(19) United States
(12) Patent Application Publication
(10) Pub. No.: US 2005/0216770 A1
(43) Pub. Date: Sep. 29, 2005

(54) Intrusion detection system

(75) Inventors: Kevin Jerome Rowett, Cupertino, CA (US); Somsubhra Sikdar, San Jose, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/125,956

(22) Filed: May 9, 2005

Related U.S. Application Data
(63) Continuation-in-part of application No. 10/351,030, filed on Jan. 24, 2003.
(60) Provisional application No. 60/639,002, filed on Dec. 21, 2004.

(51) Int. Cl. H04L 9/00

(52) U.S. Cl. 713/201

(57) ABSTRACT

An Intrusion Detection System (IDS) can be embedded in different network processing devices distributed throughout a network. In one example, a Reconfigurable Semantic Processor (RSP) performs the intrusion detection operations in multiple network routers, switches, servers, etc. that are distributed throughout a network. The RSP conducts the intrusion detection operations at network line rates without having take scanning operations offline. The RSP generates tokens that identify different syntactic elements in the data stream that may be associated with a virus or other type of malware. The tokens are in essence a by-product of the syntactic parsing that is already performed by the RSP. This allows virus or other types of malware detection to be performed with relatively little additional processing overhead. Because the tokens are generated and associated with particular types of data content, detection is more effective and can scale better than conventional brute force virus and malware detection schemes that compare every threat signature with every byte in the data stream.

### CROSS REFERENCE TO RELATED APPLICATIONS

This application claims priority of U.S. provisional patent application No. 60/639,002, filed Dec. 21, 2004, and is a continuation-in-part of co-pending U.S. patent application Ser. No. 10/351,030, filed Jan. 24, 2003.

### BACKGROUND

Security is a problem in networks and Personal Computers (PCs). The vast majority of virus attacks against Microsoft® Windows® based PCs are via email messages and scripts in web pages. The format of the data in the attack is typically binary machine code or ASCII text.

An Intrusion Detection System (IDS) typically compares every byte in every packet of a data stream with static signatures that identify different known viruses. The signatures are based on previously identified virus attacks and are manually input into a static signature file that is then accessed by the IDS software. The anti-virus software identifies email messages in an incoming packet stream and compares every byte in the email message with every virus signature in the signature file. The anti-virus software then filters out any incoming files, packets, attachments, etc. that match any of the signatures in the signature file.

Incoming data may be fragmented into multiple Internet Protocol (IP) packets that are only reassembled at a network transmission layer. The routers or switches that transfer the packets between different PCs may not perform transmission layer operations and therefore may not reassemble the different packet fragments together. This prevents the router or switch from detecting viruses that extend across multiple packet fragments. When the fragmented packets are finally combined together in a PC, network server, or other endpoint, the virus spanning the multiple fragmented packets has then already accessed the network.

Anti-virus software in PCs does operate at the application layer. However, the desktop anti-virus software has to be continuously upgraded with new virus signatures and is often not well maintained by the PC owner. The packet payloads containing a virus can have variable offsets. This requires virus signature scanning techniques to operate on a sliding window that also compares every bit in the scanned data with hundreds or thousands of different signatures. The processing required to conduct these signature scans is typically not available on desktop computers.

Some anti-virus systems only operate at particular access points in a network, for example, at a company firewall connected to the public Internet or at the company email server. These perimeter intrusion detection systems may only have limited effectiveness in detecting and removing viruses. For example, a company employee may receive an infected email over a personal email account when operating a PC from home. The employee might then bring the PC to work and unintentionally send the infected email to fellow employees over the company network. The anti-virus software operating on the company firewall and email server may not filter the emails sent internally between different employee email accounts.

The present invention addresses this and other problems associated with the prior art.

### SUMMARY OF THE INVENTION

An Intrusion Detection System (IDS) can be embedded in different network processing devices distributed throughout a network. In one example, a Reconfigurable Semantic Processor (RSP) performs the intrusion detection operations in multiple network routers, switches, servers, etc. that are distributed throughout a network. The RSP conducts the intrusion detection operations at network line rates without having to take scanning operations offline.

The RSP generates tokens that identify different syntactic elements in the data stream that may be associated with a virus or other type of malware. The tokens are in essence a by-product of the syntactic parsing that is already performed by the RSP. This allows virus or other types of malware detection to be performed with relatively little additional processing overhead. Because the tokens are generated and associated with particular types of data content, detection is more effective and can scale better than conventional brute force virus and malware detection schemes that compare every threat signature with every byte in the data stream.

The tokens can be dynamically generated from the incoming data stream and compared with pre-generated threat signatures. If a match is detected between one of the tokens and the threat signatures, a filter can be generated that removes the associated packets from the data stream. To prevent detection by an intruder, the RSP, or the appliance containing the RSP, may delay the packet for a fixed time period while generating the new filters. Another feature reassembles fragmented packets back together before generating the tokens and associated filters. This allows the IDS to detect a virus or other malware that may extend across multiple packet fragments.

In another aspect of the intrusion detection system, a central intrusion detector may use the tokens generated from different network processing devices to more intelligently protect against virus or other malware attacks and dynamically generate new filters and possibly new threat signatures that are then distributed to the network processing devices.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1A is a block diagram showing an Intrusion Detection System (IDS) implemented in a private network.

FIG. 1B shows the limitations of a conventional intrusion detection system.

FIG. 1C shows one embodiment of the IDS in FIG. 1 that identifies syntactic elements in a data stream and uses the syntactic elements to identify threats.

FIG. 2 is a block diagram showing how the IDS is implemented using a Reconfigurable Semantic Processor (RSP).

FIG. 3 is a flow diagram showing how the IDS in FIG. 2 operates.

FIG. 4 is a more detailed logic diagram of the IDS shown in FIG. 2.

FIG. 5 is a block diagram of the RSP shown in FIG. 2.

FIGS. 6 and 7 show how a Direct Execution Parser (DXP) in the RSP identifies packets containing email messages.

FIG. 8 is a flow chart showing how the RSP applies threat filters to a data stream.

FIG. 9 is a flow chart showing how the RSP conducts a session lookup.

FIG. 10 is a flow chart showing how the RSP generates tokens from the input stream.

FIG. 11A is a flow chart showing how the RSP reassembles fragmented packets before conducting intrusion detection operations.

FIG. 11B is a flow chart showing how the RSP reorders TCP packets before conducting intrusion detection.

FIGS. 12 and 13 show how a central intrusion detector correlates tokens generated from different network processing devices.

FIG. 14 shows how the IDS is used for modifying information or removing information from data streams.

### DESCRIPTION OF INVENTION

Intrusion Detection

In the description below the term “virus” refers to any type of intrusion, unauthorized data, spam, spyware, Denial Of Service (DOS) attack, or any other type of data, signal, or message transmission that is considered to be an intrusion by a network processing device. The term “virus” is alternatively referred to as “malware” and is not limited to any particular type of unauthorized data or message.

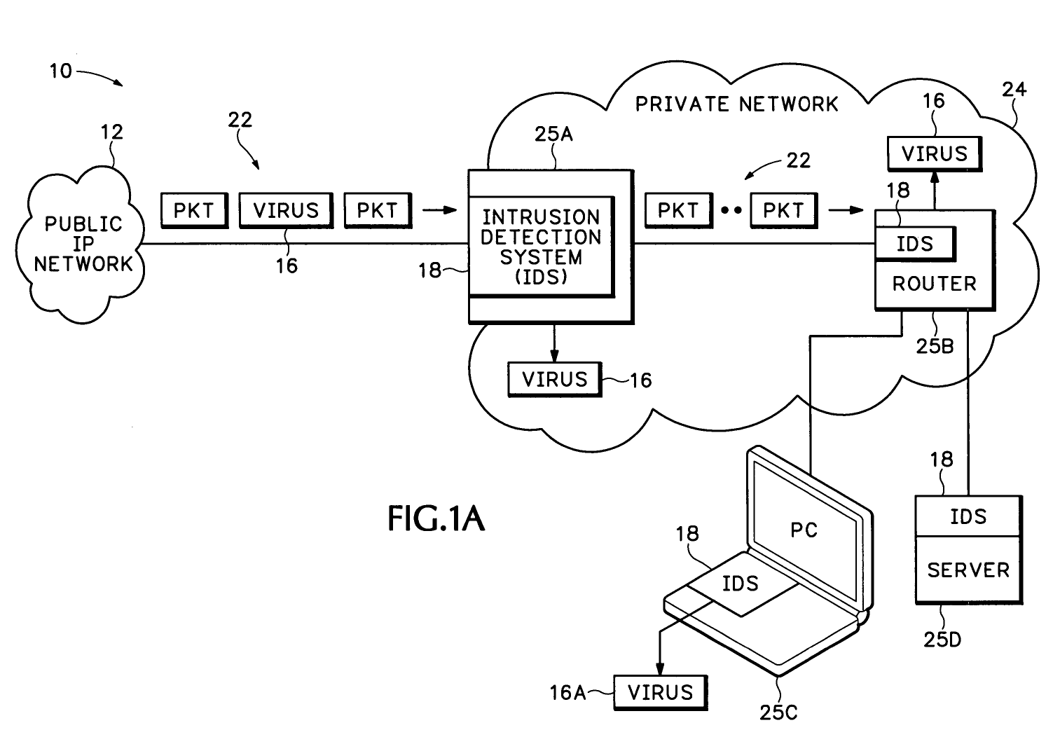

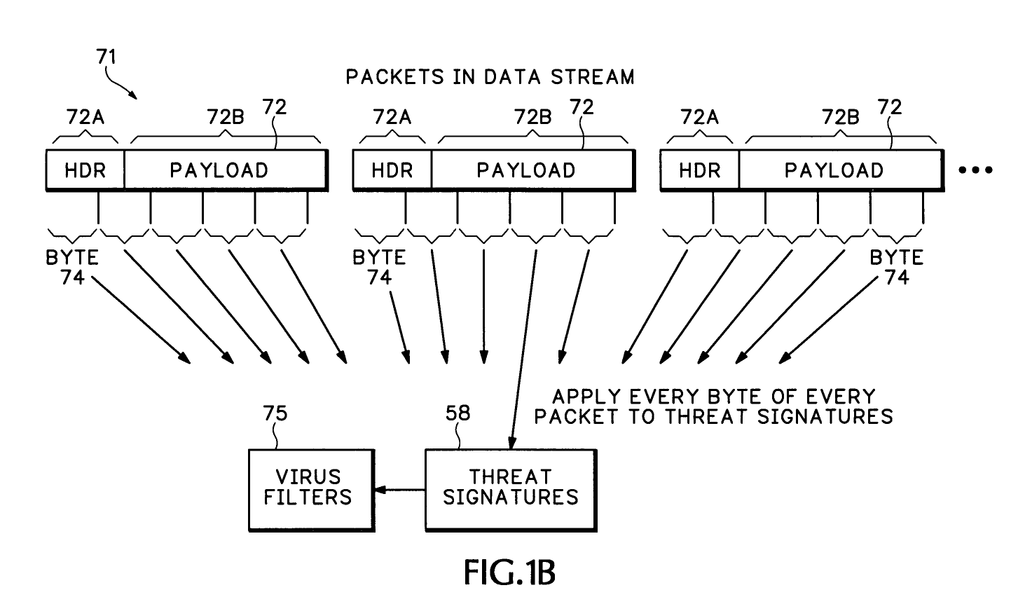

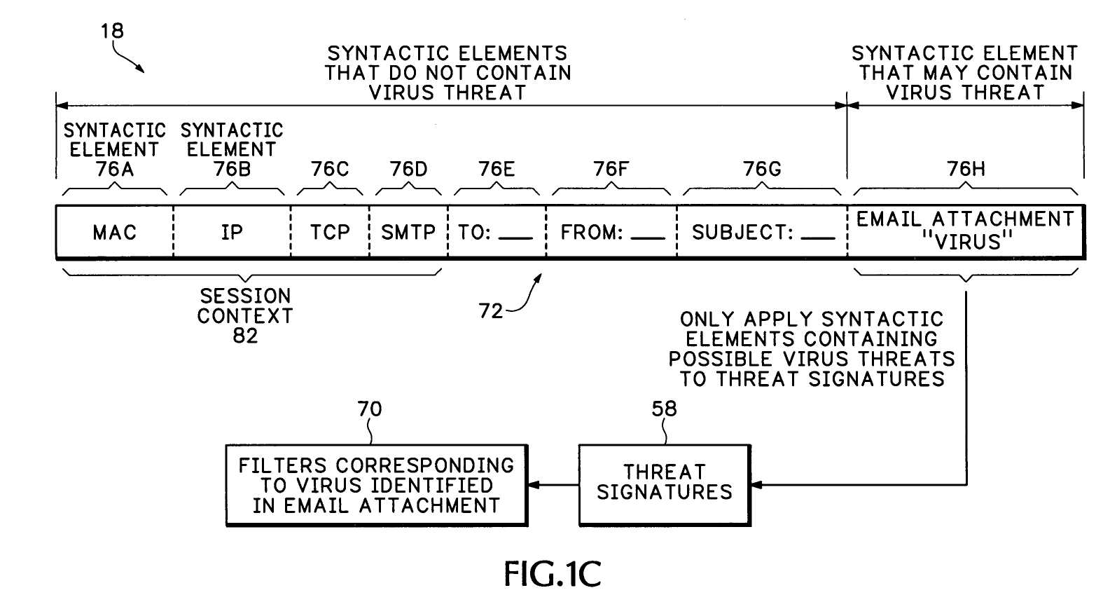

FIG. 1A shows a private IP network 24 that is connected to a public Internet Protocol (IP) network 12 through an edge device 25A. The public IP network 12 can be any Wide Area Network (WAN) that provides packet switching. The private network 24 can be a company enterprise network, Internet Service Provider (ISP) network, home network, etc. that needs to protect against attacks, such as virus or other malware attacks coming from the public network 12.

Network processing devices 25A-25D in private network 24 can be any type of computing equipment that communicate over a packet switched network. For example, the network processing devices 25A and 25B may be a routers, switches, gateways, etc. In this example, network processing device 25A operates as a firewall and device 25B operates as a router or switch, device 25C. The endpoint 25C is a Personal Computer (PC) and endpoint 25D is a server, such as an Internet Web server. The PC 25C can be connected to the private network 24 via either a wired connection such as a wired Ethernet connection or a wireless connection using, for example, the IEEE 802.11 protocol.

An Intrusion Detection System (IDS) 18 is implemented in any combination of the network devices 25A-25D operating in private network 24. Each IDS 18 collects and analyzes network traffic 22 that passes through the host network processing device 25 and identifies and discards any packets 16 within the packet stream 22 that contain a virus. In one embodiment, the IDS 18 is implemented using a Reconfigurable Semantic Processor (RSP) that is described in more detail below. However, it should be understood, that the IDS 18 is not limited to implementations using the RSP and other processing devices can also be used.

In one example, the IDS 18 is installed in the edge router 25A that connects the private network 24 to the outside public network 12. In other embodiments, the IDS 18 may also be implemented in network processing devices that do not conventionally conduct IDS operations. For example, the IDS 18 may also be implemented in the router or switch 25B. In yet another embodiment, the IDS 18 may also be implemented in one or more of the endpoints devices, such as in the PC 25C or in the Web server 25D. Implementing intrusion detection systems 18 in the multiple different network processing devices 25A-25D provide more through intrusion detection and can remove a virus 16 that enters the private network 24 through multiple different access points, other than through edge router 25A. For example, a virus that accesses the private/internal network 24 through an employees personal computer 25C can be detected and removed by the IDS 18 operating in the PC 25C, router 25B or server 25D.

In another embodiment, the IDSs 18 in the network processing devices 25 are used to detect and remove a virus 16A that originates in the private network 24. For example, the operator of PC 25C may generate the virus 16A that is directed to a network device operating in the public IP network 12. Any combination of IDSs 18 operating in the internal network 24 can be used to identify and then remove the virus 16A before it is output to the public IP network 12.

The semantic processor allows anti-virus operations to be embedded and distributed throughout network 24. For example, the semantic processor can conduct intrusion detection operations in multiple ports of network router or switch 25B. The embedded intrusion detection system IDS 18 is more robust and provides more effective intrusion detection than current perimeter antivirus detection schemes. The intrusion detection scheme is performed on data flows at network transmit speeds without having to process certain suspect data types, such as email attachments, offline.

Intrusion Detection Using Syntactic Elements

FIG. 1B shows how a conventional intrusion detection system generates filters. An input data stream 71 contains multiple packets 72. The packets 72 contain one or more headers 72A and a payload 72B. The conventional intrusion detection system indiscriminately compares each byte 74 of each packet 72 in the data stream 71 to the threat signatures 58. Any filters 75 generated by the threat signature comparisons are then applied to the entire data stream 71.

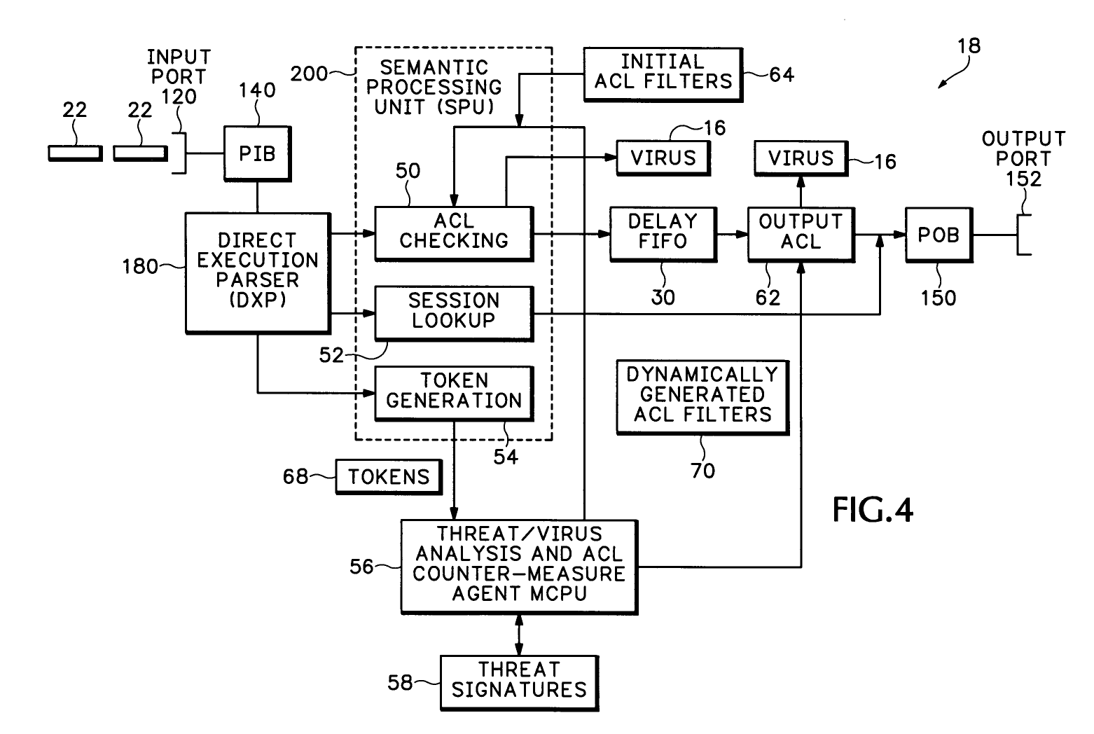

This intrusion detection scheme unnecessarily wastes computing resources. For example, some of the information in data stream 71, such as certain header data 72A, may never contain a threat. Regardless, the intrusion detection system in FIG. 4B blindly compares every byte in data stream 71 to the threat signatures 58. This unnecessarily burdens the computing resources performing the intrusion detection.

The intrusion detection scheme in FIG. 1B also does not discriminate between the context of packets that are being scanned for viruses. For example, the threat signatures 58 associated with an email virus are applied to every packet 72, regardless of whether or not the packet 72 actually contains an email message. Thus, threat signatures 58 that are associated with an email virus may be compared with packets 72 containing HTTP messages. This further limits the scalability of the intrusion detection system.

FIG. 1C is an illustration showing one embodiment of the IDS 18 that identifies syntactic elements in a data stream to more efficiently detect viruses. The IDS 18 uses a parser to identify a session context 82 associated with the packet 72. For example, one or more of the Media Access Control (MAC) address 76A, Internet Protocol (IP) address 76B, and Transmission Control Protocol (TCP) address 76C may be identified during an initial parsing operation. In this example, the parser may also identify the packet 72 as containing an Simple Mail Transport Protocol (SMTP) email message. These identifiers 76A-76D of the session context 82 are alternatively referred to as syntactic elements.

Identifying the syntactic elements 76 allows the IDS 18 to more effectively detect and remove viruses or other malware threats. For example, the IDS 18 can customize further intrusion detection operations based on the session context 82 discovered at the beginning of the packet 72. For instance, the session context 82 identifies packet 72 as containing an email message. The IDS 18 can then look for and identify additional syntactic elements 76E-76H associated specifically with email messages. And more specifically, identify email semantic elements that may contain a virus.

For example, the IDS 18 identifies semantic elements 76E-76G that contain information regarding the “To:”, “From:”, and “Subject:” fields in the email message. The IDS 18 may also identify an email attachment 76H that is also contained in the email message. In this example, a virus or malware might only be contained in the syntactic element 76H containing the email attachment. The other syntactic elements 76A-76G may not pose intrusion threats. Accordingly, only the syntactic element 76H containing the email attachment is compared with the threat signatures 58.

The information in the other syntactic elements 76A-76G may then be used to help generate the filters 70 used for filtering packet 72. For example, a filter 70 may be generated that filters any packets having the same “From:” field identified in syntactic element 76F or the same IP source address identified in syntactic element 76B.

Thus, the IDS 18 can detect intrusion attempts based on the IP session context 82, traffic characteristics and syntax 76 of a data stream. The intrusions are detected by then comparing the syntactic elements 76 identified in the network traffic against threat signature rules 58 describing events that are deemed troublesome. These rules 58 can describe any activities (e.g., certain hosts connecting to certain services), what activities are worth alerting (e.g., attempts to a given number of different hosts constitutes a “scan”), or signatures describing known attacks or access to known vulnerabilities.

Fixed Packet Delay

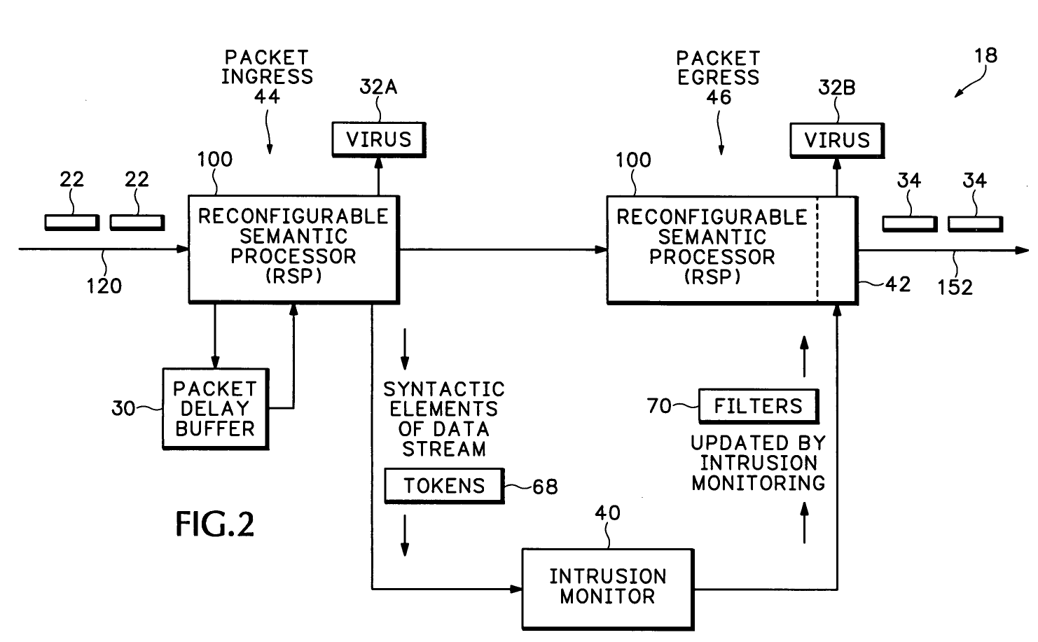

FIG. 2 shows a delay buffer that is used in combination with the IDS 18. An intrusion monitor operation 40 can be performed locally within a Reconfigurable Semantic Processor (RSP) 100 or can be performed in combination with other intrusion monitoring circuitry that operates either within the RSP 100 or externally from the RSP 100.

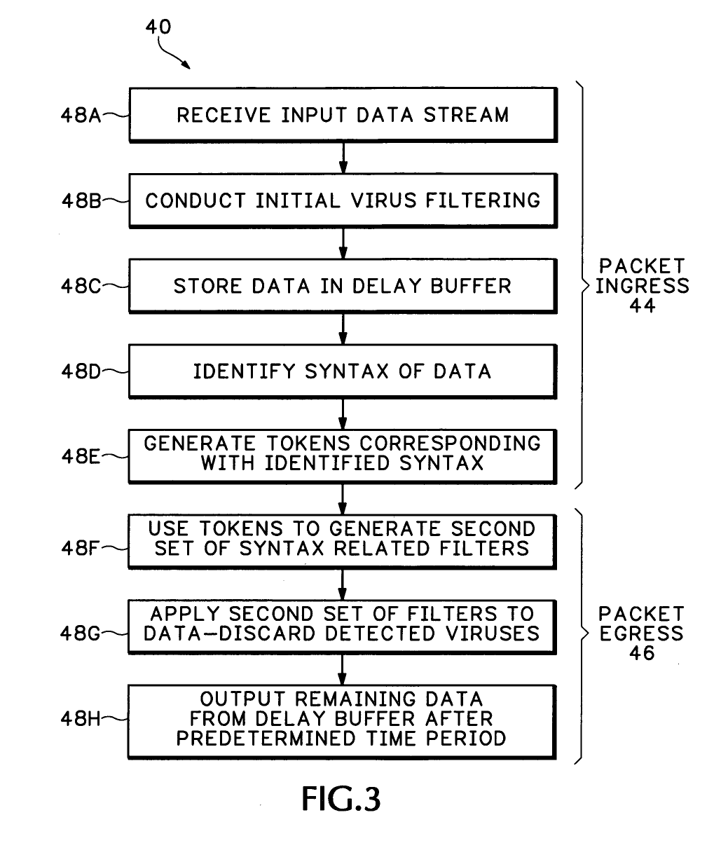

Referring to FIGS. 2 and 3, in block 48A, the RSP 100 receives packets 22 from an input port 120. The RSP 100 in block 48B may conduct a preliminary threat filtering operation that discards a first category of packets 32A that contain a virus or other type of threat. This initial filtering 48B may be performed for example by accessing a table of predetermined well known threat signatures. This initial filtering restricts certain data 32A from having to be further processed by the IDS 18. For example, a denial of service attack, well known virus attack, or unauthorized IP session can be detected and the associated packets dropped without having to be further processed by IDS 18.

In block 48C, the RSP 100 stores the remaining packets 22 into a packet delay buffer 30. In one example, the packet delay buffer 30 is a Dynamic Random Access Memory (DRAM) or some other type of memory that is sized to temporarily buffer the incoming data stream 22. In block 48D, the RSP 100 further identifies the syntax of the input data stream. For example, the RSP 100 may identify packets that contain electronic mail (email) messages.

The vast majority of intrusion attacks against Windows© based PCs are from email messages that arrive as files or scripts in the messages. The format of the data in the attack is simple binary machine code or ASCII text. The messages must meet the syntax and semantics of the delivery mechanism before they can be activated. For example, executable files in email messages are transported using the Simple Mail Transfer Protocol/Point of Presence (SMTP/POP) protocol using a Multipurpose Internet Mail Extensions (MIME) file attachment as specified in Request For Comment (RFC) 822. Therefore, the RSP 100 in block 48D may identify packets in block 48D corresponding with the SMTP and/or MIME protocols.

In block 48E, the RSP 100 generates tokens 68 that correspond to the identified syntax for the data stream 22. For example, the tokens 68 may contain particular sub-elements of the identified email message such as the sender of the email message (“From: ______”), receiver of the email message (“To: ______”), subject of the email message (“Subject: ______”), time the email was sent (“Sent: ______”), attachments contained in the email message, etc. Because the RSP 100 examines this session information, threat filtering in network processing devices, such as routers and switches, is not limited to elements found in just a single packet i.e.—attempt to hijack a TCP session, or divert an FTP stream, or forge a HTTPS certificate.

The tokens 68 are used in block 48F to dynamically generate a second more in-depth set of filters 70 that are customized to the syntax of data contained within the packet delay buffer 30. For example, the tokens 68 may be used to generate filters 70 associated with viruses contained in email messages. This is important to the scalability of the IDS 18. By generating filters associated with the syntax of the data, the IDS can more efficiently scan for threats. For example, the IDS 18 does not have to waste time applying filters that are inapplicable to the type of data currently being processed.

The RSP 100 in block 48G applies this customized filter set 70 to the data stored in the packet delay buffer 30. Any packets 32B containing a threat identified by the filters 70 are discarded. After the data has been stored in packet delay buffer 30 for a predetermined fixed time period, the RSP 100 in block 48H outputs the data to the output port 152.

The fixed delay provided by packet delay buffer 30 provides time for the monitor operation 40 to evaluate a threat, decide if a new threat is in the process of incurring, form a set of syntax related filters 70, and apply the filters before the data 34 is output from output port 152. Typically delays in delay buffer 30 for 1 Gigabit per second (Gbps) Ethernet LAN systems would be somewhere around 20 to 50 milliseconds (ms). Of course other fixed delay periods can also be used.

The RSP 100 uses a novel parsing technique for processing the data stream 22. This allows the RSP 100 to implement the IDS 18 at the line transfer rate of the network without having to take the intrusion monitoring operations 40 off-line from other incoming network routing operations that may be performed in the same network processing device. This allows the RSP 100 to process the incoming packets 22 at a fixed packet delay making it harder for an intruder to identify and avoid network processing devices 25 (FIG. 1) that operate intrusion detection systems.

For example, an intruder may monitor network delays while trying to infect private network 24 (FIG. 1) with virus 16. If a longer response is identified through one particular network path in response to repeated virus attacks, the intruder may determine that the path includes an intrusion detection system. If another network path does not take longer to respond to the attempted attack, the intruder may conclude that path does not contain an intrusion detection system and may send viruses through the ports or devices in the identified network path.

By creating a uniform packet delay between input port 120 and output port 152 regardless of the type of data 22 or the types of filters 70 generated and applied to the data stream 22, the IDS 18 prevents intruders from identifying network processing devices 25 operating IDS 18. Of course, this is just one embodiment, and other IDS implementations 18 may not be implemented using the constant packet delay.

In an alternative embodiment, the RSP 100 only applies the fixed delay to certain types of identified data while other data is processed without applying the fixed delay. By identifying the syntax of the data streams, the IDS 18 can identify the data streams that need to be scanned for viruses and the data streams that do not need to be scanned. The IDS 18 then intelligently applies the fixed delay only to the scanned data streams. For example, the RSP 100 may apply a fixed delay to packets identified as containing a TCP SYN message. If no irregularities are detected in the SYN packets, the RSP 100 may receive and process subsequently received TCP data packets without applying the fixed delay described above in FIG. 3. Thus, the non-established TCP session may be delayed while other traffic is not delayed.

FIG. 4 is a more detailed description of the operations performed by the IDS 18 shown in FIG. 3. Packets from the data stream 22 are received over input port 120 by Packet Input Buffer (PIB) 140. Bytes from the packets 22 are processed by a Direct Execution Parser (DXP) 180 and a Semantic Processing Unit (SPU) 200. In this example, one or more SPUs 200 can concurrently execute an Access Control List (ACL) checking operation 50, session lookup operation 52, and a token generation operation 54.

The ACL checking operation 50 checks the incoming packets in data stream 22 against an initial ACL list of filters 64 that are known a priori. The ACL checking operation 50 removes packets matching the ACL filters 64 and then loads the remaining packets 22 into the delay FIFO 30.

The session lookup operation 52 checks the packets 22 against known and valid IP sessions. For example, the DXP 180 may send information to session lookup 52 identifying a TCP session, port number, and arrival rate for a TCP SYN message. The session lookup 52 determines if the TPC session and port number have been seen before and how long ago. If the packets 22 qualify as a valid TCP/IP session, the packets 22 may be sent directly to the Packet Output Buffer (POB) 150.

The token generation operation 54 generate tokens 68 according to the syntax of the data stream 22 identified by the DXP 180. In one example, the token generator 54 produces tokens 68 that contain a 5 tuple data set that include the source IP address, destination IP address, source port number, destination port number and protocol number associated with the packets processed in input buffer 140. The tokens 68 may also include any anomalies in the TCP packet such as unknown IP or TCP options.

In the example described below, some of the tokens 68 also include syntactic elements associated with email messages. For example, the DXP 180 may identify packets associated with a Simple Mail Transport Protocol (SMTP) session as described above in FIG. 1C. The token generation operation 54 then extracts particular information from the email session such as a SMTS/MIME attachment. One example of a token 68 associated with an email message is generated using a Type, Length, Value (TLV) format as follows:
Token #1
Type: SMTP/MIME Attachment (method for transferring files in email messages)
Length: # of bytes in the file
Value: actual file

In another example, the DXP 180 identifies packets 22 in input buffer 140 associated with a Hyper-Text Markup Language (HTML) session. The token generation operation 54 accordingly generates tokens specifically associated and identifying the HTMP session as follows:
Token #2
Type: HTML Bin Serve (method for transferring files in web pages)
Length: # of bytes in file
Value: actual file

The tokens 68 are formatted by the token generation operation 54, such as described above, so that the syntactic information contained in the tokens 68 can be easily compared with threat signatures 58 by the threat/virus analysis and ACL counter-measure agent 56. The counter-measure agent 56 in one example is a general purpose Central Processing Unit (CPU) that compares the tokens 68 with the predefined threat signatures 58 stored in a memory. For example, the counter-measure agent 56 may implement various preexisting algorithms such as “BRO”—http://ee.lbl.gov/bro.html or “SNORT”—http://www.snort.org, which are both herein incorporated by reference, to decide if a new intrusion filter is needed. The threat signatures 58 may be supplied by a commercially available intrusion detection database such as available from SNORT or McAfee.

The counter measure agent 56 dynamically generates output ACLS filters 70 corresponding with matches between the tokens 68 and the threat signatures 58. For example, the threat signatures 58 may identify a virus in an email attachment contained in one of the tokens 68. The counter measure agent 56 then dynamically generates a filter 70 that contains the source IP address of a packet containing the virus infected email attachment. The filter 70 is output to an ACL operation 62 that then discards any packets 16 in delay FIFO 30 containing the source IP address identified by filter 70. The remaining packets are then output to output buffer 150.

Reconfigurable Semantic Processor (RSP)

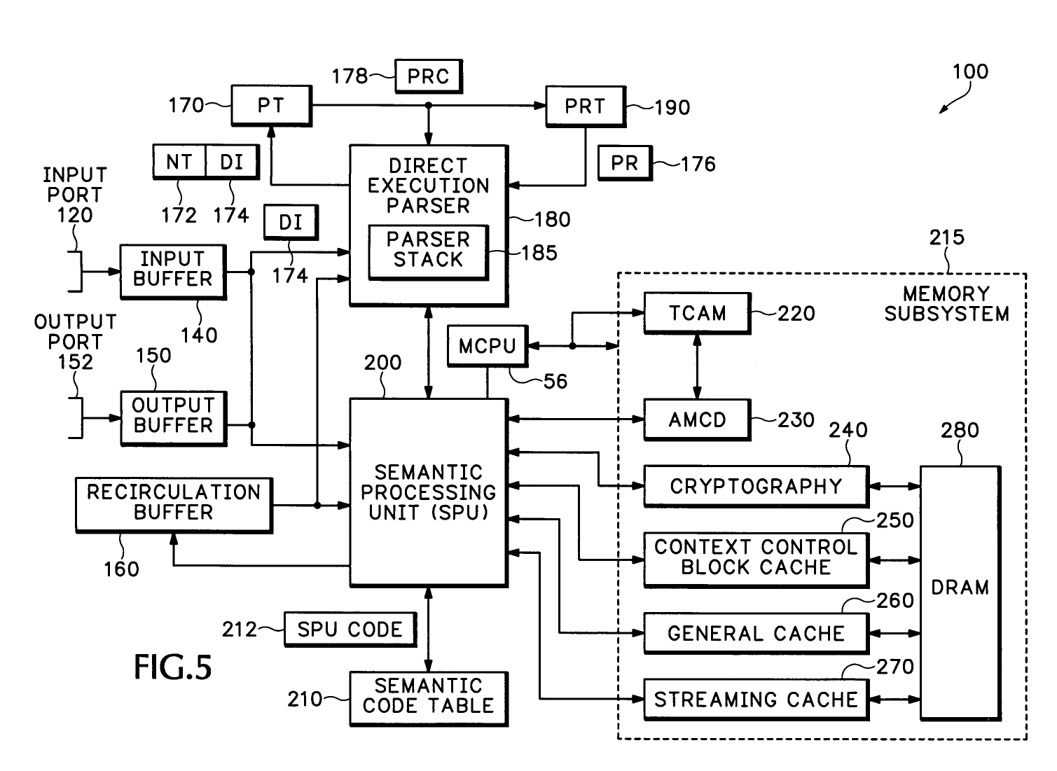

FIG. 5 shows a block diagram of the Reconfigurable Semantic Processor (RSP) 100 used in one embodiment for implementing the IDS 18 described above. The RSP 100 contains an input buffer 140 for buffering a packet data stream received through the input port 120 and an output buffer 150 for buffering the packet data stream output through output port 152.

The Direct Execution Parser (DXP) 180 controls the processing of packets or frames received at the input buffer 140 (e.g., the input “stream”), output to the output buffer 150 (e.g., the output “stream”), and re-circulated in a recirculation buffer 160 (e.g., the recirculation “stream”). The input buffer 140, output buffer 150, and recirculation buffer 160 are preferably first-in-first-out (FIFO) buffers. The DXP 180 also controls the processing of packets by the Semantic Processing Unit (SPU) 200 that handles the transfer of data between buffers 140, 150 and 160 and a memory subsystem 215. The memory subsystem 215 stores the packets received from the input port 120 and also stores the threat signatures 58 (FIG. 4) used for identifying threats in the input data stream.

The RSP 100 uses at least three tables to perform a given IDS operation. Codes 178 for retrieving production rules 176 are stored in a Parser Table (PT) 170. Grammatical production rules 176 are stored in a Production Rule Table (PRT) 190. Code segments executed by SPU 200 are stored in a Semantic Code Table (SCT) 210. Codes 178 in parser table 170 are stored, e.g., in a row-column format or a content-addressable format. In a row-column format, the rows of the parser table 170 are indexed by a non-terminal code NT 172 provided by an internal parser stack 185. Columns of the parser table 170 are indexed by an input data value DI[N] 174 extracted from the head of the data in input buffer 140. In a content-addressable format, a concatenation of the non-terminal code 172 from parser stack 185 and the input data value 174 from input buffer 140 provide the input to the parser table 170.

The production rule table 190 is indexed by the codes 178 from parser table 170. The tables 170 and 190 can be linked as shown in FIG. 5, such that a query to the parser table 170 will directly return a production rule 176 applicable to the non-terminal code 172 and input data value 174. The DXP 180 replaces the non-terminal code at the top of parser stack 185 with the production rule (PR) 176 returned from the PRT 190, and continues to parse data from input buffer 140.

The semantic code table 210 is also indexed according to the codes 178 generated by parser table 170, and/or according to the production rules 176 generated by production rule table 190. Generally, parsing results allow DXP 180 to detect whether, for a given production rule 176, a code segment 212 from semantic code table 210 should be loaded and executed by SPU 200.

The SPU 200 has several access paths to memory subsystem 215 which provide a structured memory interface that is addressable by contextual symbols. Memory subsystem 215, parser table 170, production rule table 190, and semantic code table 210 may use on-chip memory, external memory devices such as synchronous Dynamic Random Access Memory (DRAM)s and Content Addressable Memory (CAM)s, or a combination of such resources. Each table or context may merely provide a contextual interface to a shared physical memory space with one or more of the other tables or contexts.

A Maintenance Central Processing Unit (MCPU) 56 is coupled between the SPU 200 and memory subsystem 215. MCPU 56 performs any desired functions for RSP 100 that can reasonably be accomplished with traditional software. These functions are usually infrequent, non-time-critical functions that do not warrant inclusion in SCT 210 due to complexity. Preferably, MCPU 56 also has the capability to request the SPU 200 to perform tasks on the MCPU's behalf. In one implementation, the MCPU 56 assists in the generation of an Access Control List (ACL) used by the SPU 200 to filter viruses from the incoming packet stream.

The memory subsystem 215 contains an Array Machine-Context Data Memory (AMCD) 230 for accessing data in DRAM 280 through a hashing function or content-addressable memory (CAM) lookup. A cryptography block 240 encrypts, decrypts, or authenticates data and a context control block cache 250 caches context control blocks to and from DRAM 280. A general cache 260 caches data used in basic operations and a streaming cache 270 caches data streams as they are being written to and read from DRAM 280. The context control block cache 250 is preferably a software-controlled cache, i.e. the SPU 200 determines when a cache line is used and freed. Each of the circuits 240, 250, 260 and 270 are coupled between the DRAM 280 and the SPU 200. A TCAM 220 is coupled between the AMCD 230 and the MCPU 56.

Detailed design optimizations for the functional blocks of RSP 100 are not within the scope of the present invention. For some examples of the detailed architecture of applicable semantic processor functional blocks, the reader is referred to co-pending application Ser. No. 10/351,030, entitled: A Reconfigurable Semantic Processor, filed Jan. 24, 2003 which is herein incorporated herein by reference.

Intrusion Detection Using RSP

The function of the RSP 100 in an intrusion detection context can be better understood with a specific example. In the example described below, the RSP 100 removes a virus or other malware located in an email message. Those skilled in the art will recognize that the concepts illustrated readily apply to detecting any type of virus or other type of malware and performing any type of intrusion detection for any data stream transmitted using any communication protocol.

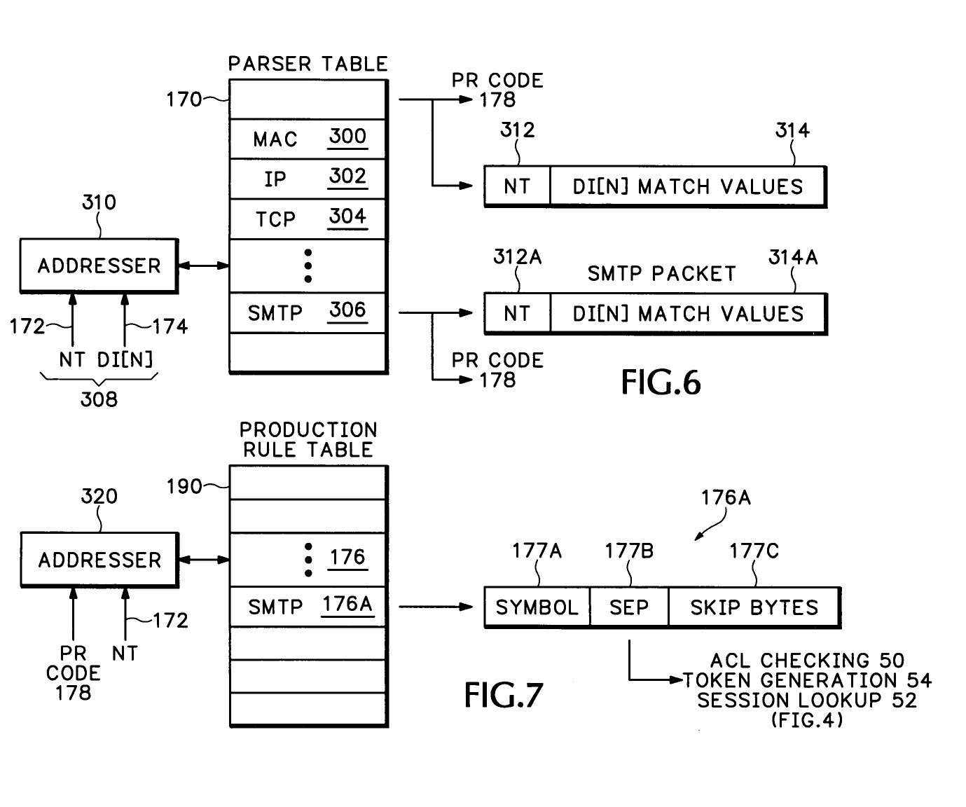

The initial intrusion detection operations include parsing and detecting a syntax of the input data stream and is explained with reference to FIGS. 6 and 7. Referring then to FIG. 6, codes associated with many different grammars can exist at the same time in the parser table 170 and in the production rule table 190. For instance, codes 300 pertain to MAC packet header format parsing, codes 302 pertain to IP packet processing, and yet another set of codes 304 pertain to TCP packet processing, etc. Other codes 306 in the parser table 170 pertain to the intrusion detection 18 described above in FIGS. 1-4 and in this example specifically identify Simple Mail Transport Protocol (SMTP) packets in the data stream 22 (FIG. 4).

The PR codes 178 are used to access a corresponding production rule 176 stored in the production rule table 190. Unless required by a particular lookup implementation, the input values 308 (e.g., a non-terminal (NT) symbol 172 combined with current input values DI[n] 174, where n is a selected match width in bytes) need not be assigned in any particular order in PR table 170.

In one embodiment, the parser table 170 also includes an addressor 310 that receives the NT symbol 172 and data values DI[n] 174 from DXP 180. Addressor 310 concatenates the NT symbol 172 with the data value DI[n] 174, and applies the concatenated value 308 to parser table 170. Although conceptually it is often useful to view the structure of production rule table 170 as a matrix with one PR code 178 for each unique combination of NT code 172 and data values 174, the present invention is not so limited. Different types of memory and memory organization may be appropriate for different applications.

In one embodiment, the parser table 170 is implemented as a Content Addressable Memory (CAM), where addressor 310 uses the NT code 172 and input data values DI[n] 174 as a key for the CAM to look up the PR code 178. Preferably, the CAM is a Ternary CAM (TCAM) populated with TCAM entries. Each TCAM entry comprises an NT code 312 and a DI[n] match value 314. Each NT code 312 can have multiple TCAM entries.

Each bit of the DI[n] match value 314 can be set to “0”, “1”, or “X” (representing “Don't Care”). This capability allows PR codes 178 to require that only certain bits/bytes of DI[n] 174 match a coded pattern in order for parser table 170 to find a match.

For instance, one row of the TCAM can contain an NT code NT_SMTP 312A for an SMTP packet, followed by additional bytes 314A representing a particular type of content that may exist in the SMTP packet, such as a label for an email attachment. The remaining bytes of the TCAM row are set to “don't care.” Thus when NT_SMTP 312A and some number of bytes DI[N] are submitted to parser table 170, where the first set of bytes of DI[N] contain the attachment identifier, a match will occur no matter what the remaining bytes of DI[N] contain.

The TCAM in parser table 170 produces a PR code 178A corresponding to the TCAM entry matching NT 172 and DI[N] 174, as explained above. In this example, the PR code 178A is associated with a SMTP packet containing an email message. The PR code 178A can be sent back to DXP 180, directly to PR table 190, or both. In one embodiment, the PR code 178A is the row index of the TCAM entry producing a match.

FIG. 7 illustrates one possible implementation for production rule table 190. In this embodiment, an addressor 320 receives the PR codes 178 from either DXP 180 or parser table 170, and receives NT symbols 172 from DXP 180. Preferably, the received NT symbol 172 is the same NT symbol 172 that is sent to parser table 170, where it was used to locate the received PR code 178.

Addressor 320 uses these received PR codes 178 and NT symbols 172 to access corresponding production rules 176. Addressor 320 may not be necessary in some implementations, but when used, can be part of DXP 180, part of PRT 190, or an intermediate functional block. An addressor may not be needed, for instance, if parser table 170 or DXP 180 constructs addresses directly.

The production rules 176 stored in production rule table 190 contain three data segments. These data segments include: a symbol segment 177A, a SPU entry point (SEP) segment 177B, and a skip bytes segment 177C. These segments can either be fixed length segments or variable length segments that are, preferably, null-terminated. The symbol segment 177A contains terminal and/or non-terminal symbols to be pushed onto the DXP's parser stack 185 (FIG. 5). The SEP segment 177B contains SPU Entry Points (SEPs) used by the SPU 200 to process segments of data. The skip bytes segment 177C contains a skip bytes value used by the input buffer 140 to increment its buffer pointer and advance the processing of the input stream. Other information useful in processing production rules can also be stored as part of production rule 176.

In this example, one or more of the production rules 176A indexed by the production rule code 178A correspond with an identified SMTP packet in the input buffer 140. The SEP segment 177B points to SPU code 212 in semantic code table 210 in FIG. 5 that when executed by the SPU 200 performs the different ACL checking 50, session lookup 52, and token generation 54 operations described above in FIG. 4. In one embodiment, the SPU 200 contains an array of semantic processing elements that can be operated in parallel. The SEP segment 177B in production rule 176A may initiate one or more of the SPUs 200 to perform the ACL checking 50, session lookup 52, and token generation 54 operations in parallel.

As mentioned above, the parser table 170 can also include grammar that processes other types of data not associated with the SMTP packets. For example, IP grammar 302 contained in parser table 170 may include production rule codes 178 associated with an identified NT_IP destination address in input buffer 140.

The matching data value 314 in the production rule codes 302 may contain the IP address of the network processing device where RSP 100 resides. If the input data DI[I] 174 associated with an NT_IP code 172 does not have the destination address contained in the match values 314 for PR codes 302, a default production rule code 178 may be supplied to production rule table 190. The default production rule code 178 may point to a production rule 176 in the production rule table 190 that directs the DXP 180 and/or SPU 200 to discard the packet from the input buffer 140.

Semantic Processing Units (SPUs)

As described above, the DXP 180 identifies particular syntactic elements in an input stream such as an IP session, TCP session, and in the present example, SMTP email sessions. These syntactic parsing operations are important to the overall performance of the IDS system 18. Since the actual syntax of the input stream is identified by DXP 180, the subsequent IDS operations described above in FIG. 4 can now be performed more effectively by the SPU 200.

For example, the SPU 200 might only have to apply ACL filters associated with email messages to the parsed data stream. This provides several advantages. First, every byte of every packet does not necessarily have to be compared with every threat signature 58 in FIG. 4. Alternatively, only a subset of threat signatures associated with email messages have to be applied to the SMTP packets. This has the substantial advantage of increasing the scalability of the IDS 18 and allows the IDS 18 to detect more viruses and malware, and operate at higher packet rates.

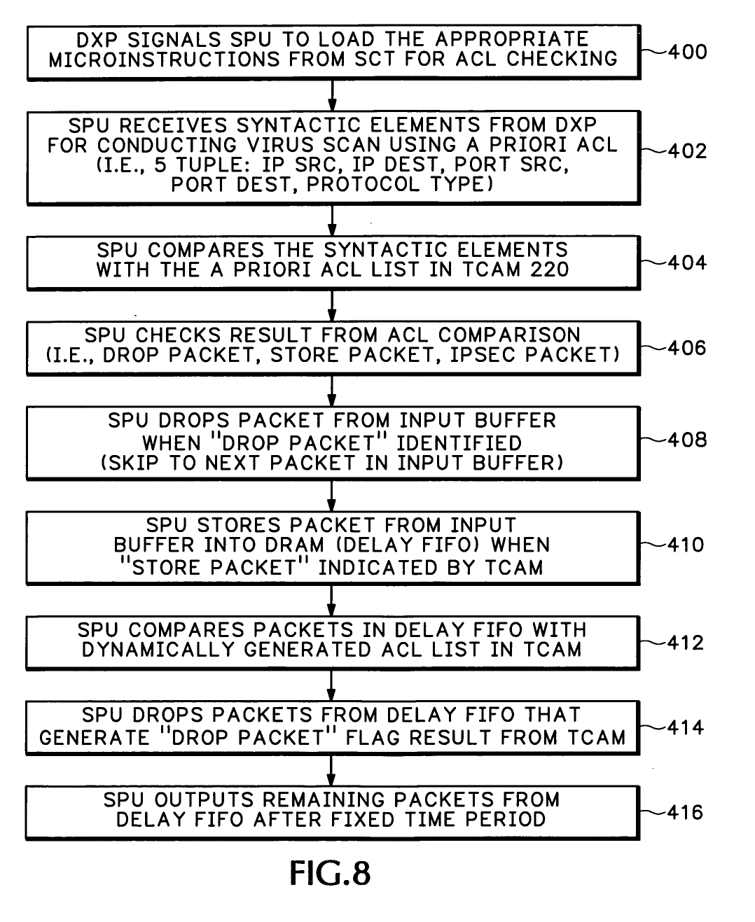

FIG. 8 describes in more detail the ACL checking operation 50 and output ACL operation 62 previously described in FIG. 4. In block 400, the DXP 180 signals the SPU 200 to load the appropriate microinstructions from the SCT 210 that perform the ACL checking operation 50 and output ACL operation 62 previously described in FIG. 4. As described above in FIG. 7, the DXP 180 signals the SPU 200 via the SPU Entry Point (SEP) segments 177B contained in the production rule 176A.

In accordance with the SPU code 212 (FIG. 5) accessed in SCT 210 responsive to the SEP segment 177B, the SPU 200 in block 402 obtains certain syntactic elements identified by the DXP 180 in the input data stream. For example, the DXP 180 may identify a 5 tuple syntactic element that includes the IP source address, IP destination address, destination port number, source port number, and a protocol type. Of course, this is only one example, and other syntactic elements in the data stream 22 (FIG. 4) can also be identified by the DXP 180.

In block 404, the SPU 200 compares the syntactic elements identified by the DXP 180 with an a priori set of Access Control List (ACL) filters contained in TCAM 220. For example, the priori set of ACL filters in TCAM 220 may contain different IP addresses associated with known threats. In one example, the SPU 200 compares the syntactic elements for the packets in input buffer 140 with the a priori filters in the TCAM 220 by sending the syntactic element, such as the IP address for packet, through the AMCD 230 to the TCAM 220. The IP address is then used as an address into TCAM 220 that outputs a result back through the AMCD 230 to the SPU 200.

The SPU 200 in block 406 checks the results from TCAM 220. The output from TCAM 220 may indicate a drop packet, store packet, or possibly a IP security (IPSEC) packet. For example, the TCAM 220 may generate a drop packet flag when the IP address supplied from the packet in input buffer 140 matches one of the a priori filter entries in the TCAM 220. A store packet flag is output when the IP address for the input data stream 22 does not match any of the entries in the TCAM 220. The TCAM 220 may also contain entries that correspond to an encrypted IPSEC packet. If the IP address matches one of the IPSEC entries, the TCAM 220 outputs an IPSEC flag.

The SPU 200 in block 408 drops any packets in PIB 140 that generate a drop packet flag in the TCAM 220. The SPU 200 can drop the packet simply by directing the input buffer 140 to skip to a next packet. If a store packet flag is output from the TCAM 220, the SPU 200 in block 410 stores the packet from the input buffer 140 into the DRAM 280. The DRAM 280 operates as the delay FIFO 30 described in FIGS. 3 and 4. If an IPSEC flag is output by the TCAM 220, the SPU 200 may send the packet in input buffer 140 through the cryptography circuit 240 in the memory subsystem 215. The decrypted packet may then be sent back to the recirculation buffer 160 in FIG. 5 and the ACL checking operation described above repeated.

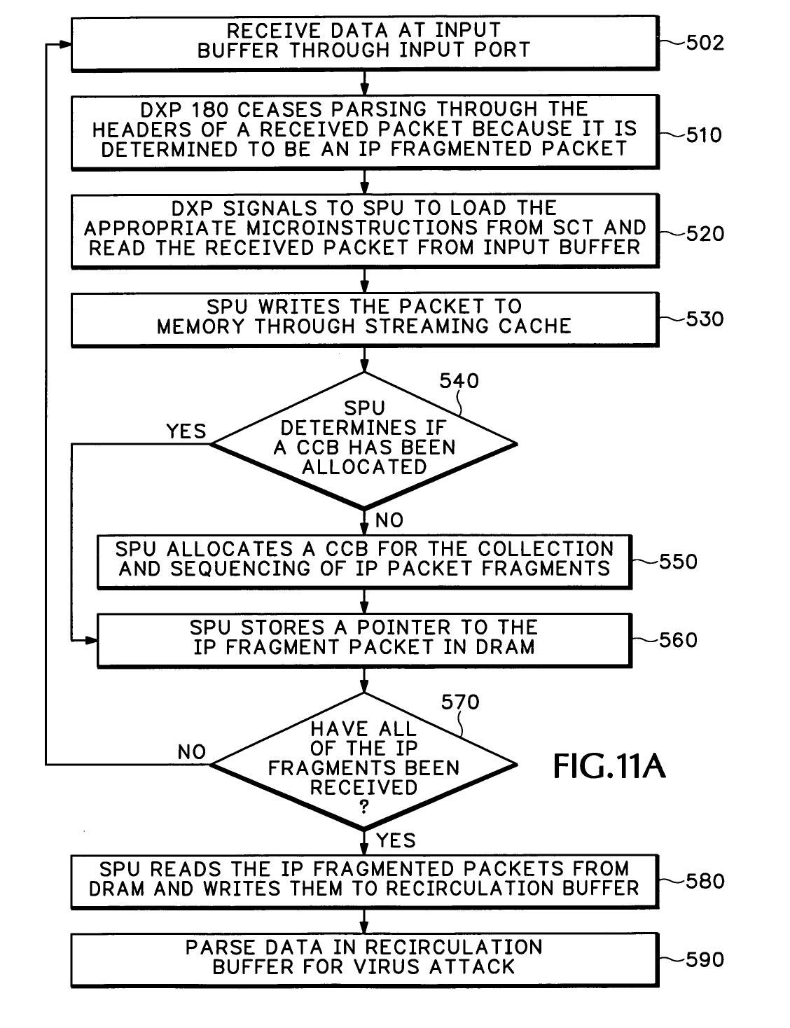

While packets are stored in the DRAM 280 (delay FIFO 30 in FIG. 4), the MCPU 56 (counter measure agent 56 in FIG. 4) dynamically generates ACL filters 70 that correspond with the tokens 68 extracted from the input data stream. This is described in more detail below in FIG. 10. The SPU 200 in block 412 compares the packets stored in DRAM 280 with the dynamically generated ACL filters 70 (FIG. 4) that are now stored in the TCAM 220. For example, the SPU 200 may uses the same 5 tuple for the packet that was identified in block 402.

The SPU 200 applies the 5 tuple for the packet to the dynamically generated filters 70 in the TCAM 220. Any packet in DRAM 280 generating a drop packet flag result from the TCAM 220 is then deleted from the DRAM 280 by the SPU 200 in block 414. After a predetermined fixed delay period, the SPU 200 in block 416 then outputs the remaining packets to the output port 152.

It should be understood that the CAM 220 can include other a priori filters. For example, the CAM 220 can include filters associated with different protocols or data that may be contained in the packets. The DXP 180 identifies the syntactic elements to the SPU 200 that need to be applied to the filters in TCAM 220.

It may not be possible to determine a virus or malware within the fixed time delay provided by the delay FIFO. For example, the virus may be contained at the end of a large multi-megabit message. In this situation, the IDS 18 may generate a virus notification message that goes to the same recipient as the packet containing the virus. The virus notification message notifies the recipient to discard the packet containing the virus.

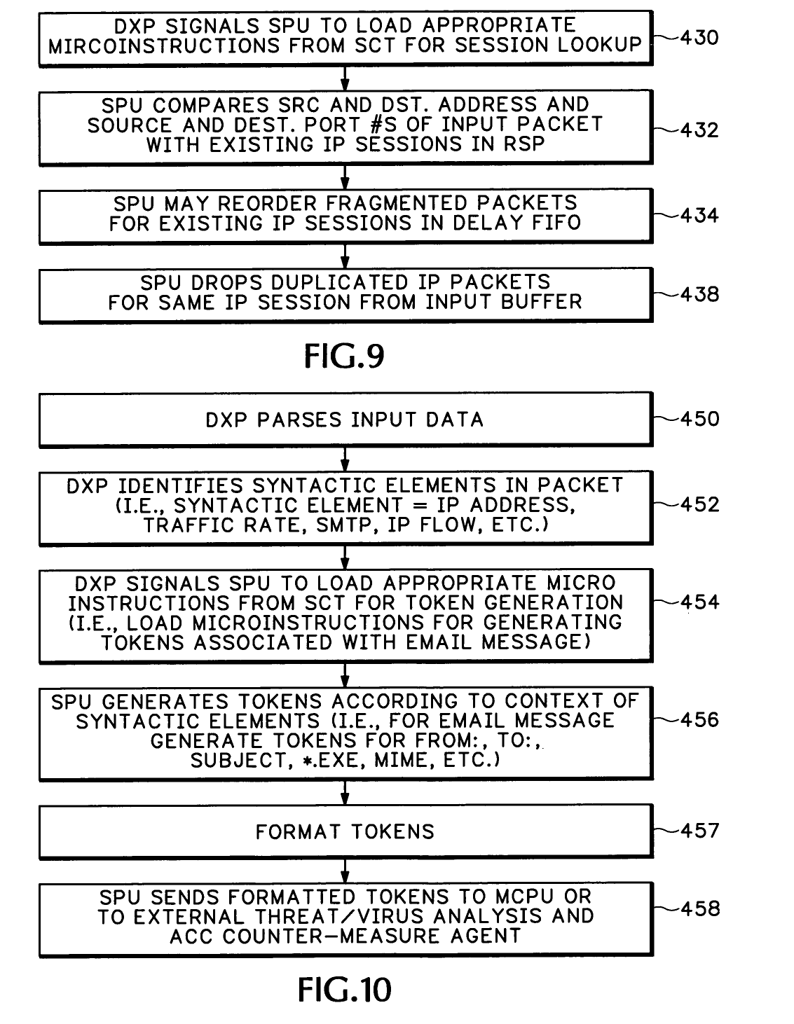

FIG. 9 explains operations performed by the SPU 200 during the session lookup operation 52 previously described in FIG. 4. In block 430, the DXP 180 signals the SPU 200 to load the appropriate microinstructions from SCT 210 associated with performing the session lookup operations by sending associated SEP segments 177B as previously described in FIG. 7.

In one example, the SPU 200 in block 432 receives the source and destination address and port number for the input packet from the DXP 180. The SPU 200 then compares the address and port numbers with current session information for packets contained in DRAM 280. For some IP sessions, the SPU 200 in block 434 may need to reorder fragmented packets in the delay FIFO 30 operated in DRAM 280. The SPU 200 in block 438 may also drop any packets in the input buffer 140 that are duplicates of previously received packets for an existing IP session.

FIG. 10 describes the token generation operation 54 previously described in FIG. 4. In block 450, the DXP 180 parses the data from the input stream as described above in FIGS. 5-7. In block 452, the DXP 180 identifies syntactic elements in the data stream in input buffer 140 that may be associated with a virus or malware. In the example above, this can include the DXP 180 identifying packets containing email messages. However, the syntactic elements identified by the DXP 180 can be anything, including IP addresses, an IP data flow that includes source and destination addresses, identified traffic rates for particular data flows, etc.

The DXP 180 in block 454 signals the SPU 200 to load the microinstructions from the SCT 210 associated with a particular token generation operation. And more specifically, the microinstructions identified by the SEP segments 177B in FIG. 7 direct the SPU 200 to generate tokens for the specific syntactic elements identified by the DXP 180.

The SPU 200 in block 456 then generates tokens 68 (FIG. 4) from the identified syntactic element. For example, the SPU code 212 (FIG. 5) may direct the SPU 200 to extract syntactic elements located for an identified email message. The SPU 200 may generate tokens that contain information from the “From:”, “To:”, and “Subject:” fields in the packet. The SPU 200 may also extract and generate a token for any email attachments that may exist in the data stream. For example, the SPU 200 might generate the TLV token #1 previously described above in FIG. 4
Token #1
Type: SMTP/MIME Attachment (method for transferring files in email messages)
Length: # of bytes in the file
Value: actual file

It should also be understood that the DXP 180 can identify many different types of syntactic elements that may be associated with a threat. The DXP 180 may launch different SPU code 212 (FIG. 5) for the different syntactic elements. For example, as described above, the DXP 180 may also identify a semantic element corresponding with an HTMP message. The DXP 180 sends a SEP segment 177B that directs the SPU 200 to generate HTML tokens that may be similar to what is shown below.
Token #2
Type: HTML Bin Serve (method for transferring files in web pages)
Length: # of bytes in file
Value: actual file

The SPU 200 in block 457 formats the tokens for easy application to the threat signatures 58 in FIG. 4. For example, the SPU 200 formats the tokens as Type, Length and Value (TLV) data. The SPU in block 458 then sends the formatted tokens to the MCPU 56 in FIG. 5 or to an external threat/virus analysis and ACL counter-measure agent 56 as described above in FIG. 4.

In one embodiment, the MCPU 56 applies the tokens 68 to the threat signatures 58 contained in the TCAM 220 producing a set dynamically generated ACL filters 70. The SPU 200 in the output ACL operation 62 described above in FIG. 8 then applies the dynamically generated ACL filters 70 in TCAM 220 to the packets stored in the DRAM 280 delay FIFO. Any packets in the delay FIFO matching the ACL filters 70 are dropped.

In this embodiment, the TCAM 220 may comprise multiple tables that include both a threat signature table and an ACL filter table. The threat signature table in TCAM 220 is accessed by the MCPU 56 and the ACL filters in the TCAM 220 are accessed by the SPUs 220 through the AMCD 230.

In alternative embodiment, an external threat analysis device operates off chip from the RSP 100. In this embodiment, a separate TCAM may contain the threat signatures. The SPU 200 sends the tokens 68 to the external threat analysis device which then outputs the dynamically generated ACL filters 70 to the MCPU 56. The MCPU 56 then writes the dynamically generated ACL filters 70 into TCAM 220. The SPU 200 then accesses the ACL filters in the TCAM 220 for the ACL checking operation 50 and the output ACL operation 62 described in FIG. 4.

The actual generation of the ACL filters 70 is known to those skilled in the art and is therefore not described in further detail. However, it is not believed that intrusion detection systems have ever previously dynamically generated ACL filters according to tokens that are associated with identified syntactic elements in the data stream.

Intrusion detection in Fragmented Packets

Text scanners currently exist that look for known patterns in Internet messages. To avoid falsely detecting a threat, long sequences of text are matched, usually with a regular expression style pattern matching technique. However, these techniques require the bytes either be contiguous, or require the threat scanner to use extensive context memory.

For example, a virus script may be contained as one long line as shown below:

For all files in:
c:\; {open (xxx); delete (xxx); close (xxx);} end.
   Accordingly, the antivirus scanner has to look for the entire text string:
s/*open(*);delete(*);close(*)*/

However, the attacker may distribute the virus among multiple packet fragments as follows:

IP frag #1: For all files in c:\; { open (xxx);
IP frag #2: delete (xxx); close (xxx);} end;

A conventional virus scanner might not be able to detect the virus in the fragmented IP packets above. At the point where the TCP/IP protocol eventually puts the fragmented message back together, the virus has then already infiltrated the private network. The RSP 100 detects and reassembles fragmented packets before conducting the intrusion detection operations described above. This allows the IDS to detect a virus that spans multiple fragmented packets.

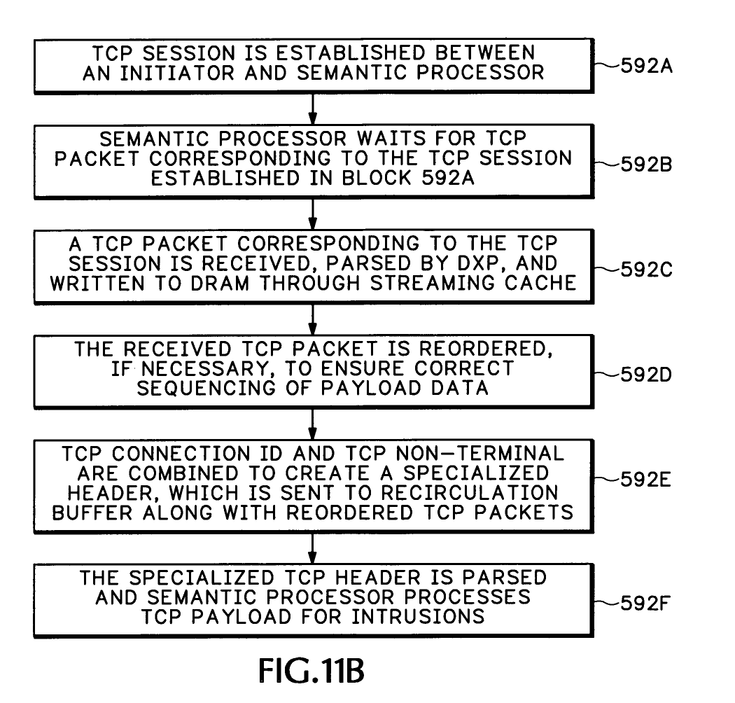

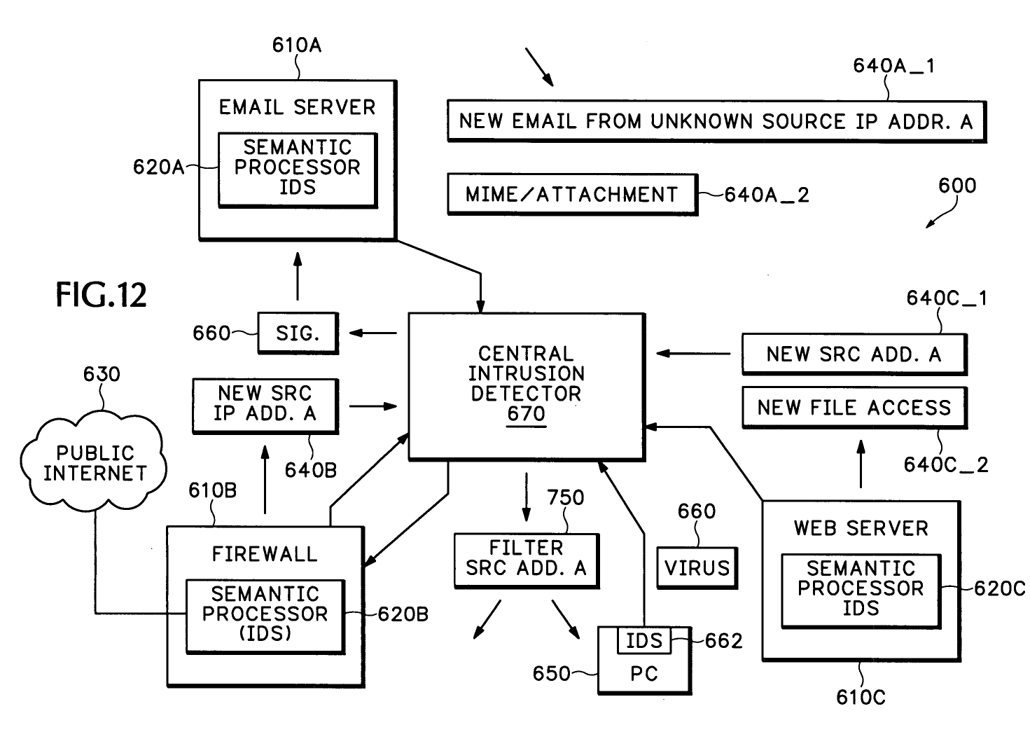

FIG. 11A contains a flow chart 500 explaining how the RSP 100 in FIG. 5 detects a virus in fragmented packets. Referring to FIGS. 5 and 11A, a packet is received at the input buffer 140 through the input port 120 in block 502. The DXP 180 in block 510 begins to parse through the headers of the packet in the input buffer 140. The DXP 180 ceases parsing through the headers of the received packet when the packet is determined to be an IP-fragmented packet. Preferably, the DXP 180 completely parses through the IP header, but ceases to parse through any headers belonging to subsequent layers (such as TCP, UDP, iSCSI, etc.). DXP 180 ceases parsing when directed by the grammar on the parser stack 185 or by the SPU 200.

According to a next block 520, the DXP 180 signals to the SPU 200 to load the appropriate microinstructions from the SCT 210 and read the fragmented packet from the input buffer 140. According to a next block 530, the SPU 200 writes the fragmented packet to DRAM 280 through the streaming cache 270. Although blocks 520 and 530 are shown as two separate steps they can be optionally performed as one step with the SPU 200 reading and writing the packet concurrently. This concurrent operation of reading and writing by the SPU 200 is known as SPU pipelining, where the SPU 200 acts as a conduit or pipeline for streaming data to be transferred between two blocks within the semantic processor 100.

According to a next decision block 540, the SPU 200 determines if a Context Control Block (CCB) has been allocated for the collection and sequencing of the correct IP packet fragment. The CCB for collecting and sequencing the fragments corresponding to an IP-fragmented packet, preferably, is stored in DRAM 280. The CCB contains pointers to the IP fragments in DRAM 280, a bit mask for the IP-fragments packets that have not arrived, and a timer value to force the semantic processor 100 to cease waiting for additional IP-fragments packets after an allotted period of time and to release the data stored in the CCB within DRAM 280.

The SPU 200 preferably determines if a CCB has been allocated by accessing the AMCD's 230 content-addressable memory (CAM) lookup function using the IP source address of the received IP fragmented packet combined with the identification and protocol from the header of the received IP packet fragment as a key. Optionally, the IP fragment keys are stored in a separate CCB table within DRAM 280 and are accessed with the CAM by using the IP source address of the received IP fragmented packet combined with the identification and protocol from the header of the received IP packet fragment. This optional addressing of the IP fragment keys avoids key overlap and sizing problems.

If the SPU 200 determines that a CCB has not been allocated for the collection and sequencing of fragments for a particular IP-fragmented packet, execution then proceeds to a block 550 where the SPU 200 allocates a CCB. The SPU 200 preferably enters a key corresponding to the allocated CCB, the key comprising the IP source address of the received IP fragment and the identification and protocol from the header of the received IP fragmented packet, into an IP fragment CCB table within the AMCD 230, and starts the timer located in the CCB. When the first fragment for given fragmented packet is received, the IP header is also saved to the CCB for later recirculation. For further fragments, the IP header need not be saved.

Once a CCB has been allocated for the collection and sequencing of the IP-fragmented packet, according to a next block 560, the SPU 200 stores a pointer to the IP-fragment (minus its IP header) packet in DRAM 280 within the CCB. The pointers for the fragments can be arranged in the CCB as, e.g. a linked list. Preferably, the SPU 200 also updates the bit mask in the newly allocated CCB by marking the portion of the mask corresponding to the received fragment as received.

According to a next decision block 570, the SPU 200 determines if all of the IP-fragments from the packet have been received. Preferably, this determination is accomplished by using the bit mask in the CCB. A person of ordinary skill in the art can appreciate that there are multiple techniques readily available to implement the bit mask, or an equivalent tracking mechanism, for use with the present invention. If all of the IP-fragments have not been received for the fragmented packet, then the semantic processor 100 defers further processing on that fragmented packet until another fragment is received.

After all of the IP-fragments have been received, according to a next block 580, the SPU 200 reads the IP fragments from DRAM 280 in the correct order and writes them to the recirculation buffer 160 for additional parsing and processing, such as the intrusion detection processing descried above. In one embodiment of the invention, the SPU 200 writes only a specialized header and the first part of the reassembled IP packet (with the fragmentation bit unset) to the recirculation buffer 160.

The specialized header enables the DXP 180 to direct the processing of the reassembled IP-fragmented packet stored in DRAM 280 without having to transfer all of the IP fragmented packets to the recirculation buffer 160. The specialized header can consist of a designated non-terminal symbol that loads parser grammar that includes the IDS operations 18 and a pointer to the CCB. The parser 180 then parses the IP header normally, and proceed to parse higher-layer (e.g., TCP) headers. When a syntactic element is identified in the reassembled packet in recirculation buffer 160 that may contain a virus, the DXP 180 signals the SPU 200 to load instructions from SCT 210 that perform the intrusion detection operations 50, 52, and 54 described above. For example, if the reassembled packet is identified as containing an email message, the DXP 180 directs the SPU 200 to generate tokens corresponding to the different email messages fields described above.

FIG. 11B contains a flow chart showing how the IDS 18 conducts intrusion operations for multiple TCP packets. According to a block 592A, a Transmission Control Protocol (TCP) session is established between an initiator and the network processing device hosting the RSP 100. The RSP 100 contains the appropriate grammar in the parser table 170 and the PRT 190 and microcode in SCT 210 to establish a TCP session. In one embodiment, one or more SPUs 200 organize and maintain state for the TCP session, including allocating a CCB in DRAM 280 for TCP reordering, window sizing constraints and a timer for ending the TCP session if no further TCP packets arrive from the initiator within the allotted time frame.

After the TCP session is established with the initiator, according to a next block 592B, RSP 100 waits for TCP packets, corresponding to the TCP session established in block 592A, to arrive in the input buffer 140. Since RSP 100 may have a plurality of SPUs 200 for processing input data, RSP 100 can receive and process multiple packets in parallel while waiting for the next TCP packet corresponding to the TCP session established in the block 592A.

A TCP packet is received at the input buffer 140 through the input port 120 in block 592C, and the DXP 180 parses through the TCP header of the packet within the input buffer 140. The DXP 180 sends the allocated SPU 200 microinstructions that, when executed, require the allocated SPU 200 to read the received packet from the input buffer 140 and write the received packet to DRAM 280 through the streaming cache 270. The allocated SPU 200 then locates a TCP CCB, stores the pointer to the location of the received packet in DRAM 280 to the TCP CCB, and restarts a timer in the TCP CCB. The allocated SPU 200 is then released and can be allocated for other processing as the DXP 180 determines.

According to a next block 592D, the received TCP packet is reordered, if necessary, to ensure correct sequencing of payload data. As is well known in the art, a TCP packet is deemed to be in proper order if all of the preceding packets have arrived. When the received packet is determined to be in the proper order, the responsible SPU 200 loads microinstructions from the SCT 210 for recirculation.

According to a next block 592E, the allocated SPU combines the TCP connection information from the TCP header and a TCP non-terminal to create a specialized TCP header. The allocated SPU 200 then writes the specialized TCP header to the recirculation buffer 160. Optionally, the specialized TCP header can be sent to the recirculation buffer 160 with its corresponding TCP payload.

According to a next block 592F, the specialized TCP header and reassembled TCP payload is parsed by the DXP 180 to identify additional syntactic elements in the TCP data. Any syntactic elements identified as possibly containing an intrusion are processed by the SPUs 200 according to the intrusion operations described above.

Distributed Token Generation

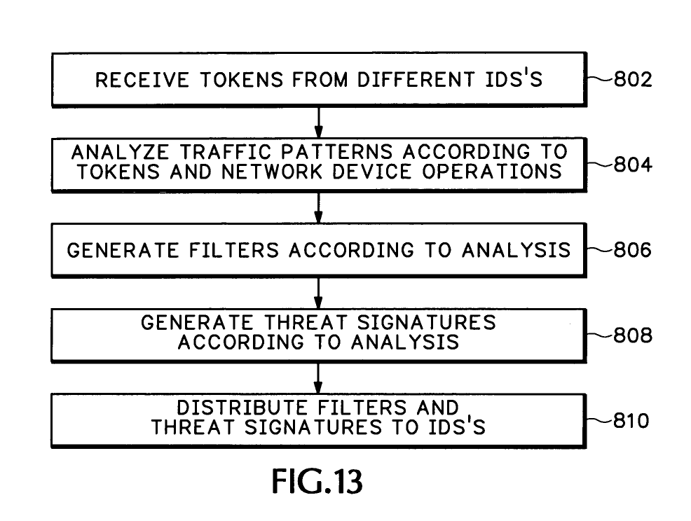

FIG. 12 shows one implementation of a distributed IDS system operating in a network 600. The network 600 includes different network processing devices 610 that perform different activities such as a firewall 610A, an email server 610B, and a Web server 610C. The different network devices 610A-C each operate an IDS 620A-C, respectively, similar to the IDS 18 discussed above. In one embodiment, one or more IDS 620 is implemented using a RSP 100 similar to that discussed above in FIGS. 5-10. However, in other embodiments, one or more IDS 620 are implemented using other hardware architectures.

Each network processing device 610 is connected to a central intrusion detector 670 that performs centralized intrusion analysis. Each IDS 620A-620C parses an input data stream and generates tokens 640A-C, respectively, similar to the tokens 68 described above in FIG. 4. The tokens 640 are sent to the central intrusion detector 670.

Referring to FIGS. 12 and 13, the central intrusion detector 670 in block 802 receives the tokens 640 from each IDS 620. The intrusion detector 670 in block 804 analyzes traffic patterns for the different data flows according to the tokens 640. Filters are then generated in block 806 and threat signatures may be generated in block 808 according to the analysis. The new filters and threat signatures are then distributed to each IDS 620 in block 810.

In one example, the firewall 610B in FIG. 12 may generate tokens 640B identifying a new data flow received from the public internet 630. The token 640B is sent to the central intrusion detector 670 identifying the new source IP address A. The Web server 610C may also send tokens 640C to the intrusion detector 670. A first token 640C_1 identifies a new source IP address A and a second token 640C_2 indicates that the new source IP address A has been used to access a file in Web server 610C.

The central intrusion detector 670 correlates the tokens 640B, 640C_1 and 640C_2 to identify a possible virus or malware that may not normally be detected. For example, the intrusion detector 670 may determine that the new source IP address A received in token 640B from the firewall 610B is the same IP address A that also opened a file in Web server 610C. External links from public Internet 630 in this example are not supposed to open internal network files.

Because token 640B was received from firewall 610B, the central intrusion detector 670 concludes that the IP address A was received externally from public Internet 630. Accordingly, the central intrusion detector 670 sends a new filter 750 to the IDS 620B in firewall 610B, and possibly to the other network devices 610A and 610C, that prevents packets with the source IP address A from entering the network 600.

In another example, the IDS 620A in the email server 610A generates a token 640A_1 that indicates that an email was received from an unknown source IP address A. The IDS 620A also sends a token 640A_2 that identifies a MIME/attachment contained in the email identified in token 640A_1.

The central intrusion detector 670 determines from the previously received tokens 640B, 640C_1, and 640C_2 that any data flows associated with the IP source address A may contain a virus or malware. Accordingly, the central intrusion detector 670 may dynamically generate a new signature 660 that corresponds with the name and/or contents of the MIME/attachment contained in token 640A_2. The central intrusion detector 670 sends the new signature 660 to the IDS 620A in the mail server 610A and possibly to every other IDS 620 operating in network 600. The IDS 620A then adds the new threat signature to the threat signatures 58 shown in FIG. 4.

Thus, the IDS system 600 may generate filters and/or signatures according to both the syntactic content of the tokens 640 and also according to the type of network processing device 610 sending the tokens. For example, tokens 640B generated by the firewall 610B may be treated more suspiciously than tokens generated from other network processing devices in the network. Also, as described above, the knowledge of new IP addresses identified by the firewall 610B (IP packets received from public Internet) can be correlated with knowledge of other operations detected by email server 610A or web server 610C to more thoroughly detect viruses.

In another embodiment, the central intrusion detector 670 may disable any of the network processing devices affiliated with a detected virus or other malware. For example, a virus 660 may be detected by an IDS 662 operated in a PC 662. The IDS 662 notifies the central intrusion detector 670 of the virus 660. The central intrusion detector 670 may then disconnect the PC 650 from the rest of the network 600 until the source of the virus 660 is identified and removed.

Scalability of Tree Search

The IDS 18 described above improves upon existing intrusion detection by scanning within a session context where threats can appear. A parser tree is used, rather than a regular expression, to pattern match. Intrusion detection and other threats in packet data is performed by “scanning” the input packet stream for patterns that match those of known threats.

Existing regular expression scanners must scan every byte of a packet and do not have the ability to determine which portion of a packet may contain a threat. For example, threats in email may only come via email attachments. The defined body of an email message is a string of ASCII characters which software generally won't act upon in an unexpected or malicious action. Attachments to email messages are defined by specific, published syntaxes and headers, such as Multipurpose Internet Mail Extensions (MIMEs).

Further, the headers of the IP protocol used to transport the email message often can not cause the email client to take malicious action. Typically, execution of a script, or program, in the email attachment cause the intrusion problem. Therefore, it may only be necessary to scan the MIME portions of an email message to detect a possible virus.

Finding the MIME portion of an email message requires an understanding of the protocols used for transporting the email messages (TCP/IP); and email MIME formats. The RSP 100 rapidly parses, and in a scalable way, initiates the virus scanning only for the MIME sections of the message. This reduces the number of packets that have to be scanned and also reduces the number of bytes that have to be scanned in each packet. The RSP 100 conducts a syntactic analysis of the input data stream allowing the IDS 18 to understand what type of data needs to be scanned and the type of scanning that needs to be performed. This allows the IDS 18 to more efficiently generate tokens 68 that correspond with the syntax of the input stream.

The DXP 180 and other features of the RSP 100 are optimized for this type of threat scanning and has improved performance compared to regular expression scanners that use convention hardware architectures. For example, an LL(k) parser, in conjunction with a Temary-Content-Addressable-Memory (TCAM) implemented in the parser table 170 and the parser stack 185 in FIG. 5 can search an input stream faster than regular expression engines.

A regular expression scanner requires significant and variable length look ahead to determine a possible match. Wild card matching also requires a unique operation. On the other hand, an LL(k) parser in combination the TCAM can skip past long strings of wildcards, and match specific bytes all in one clock cycle.

Modifying Session Content

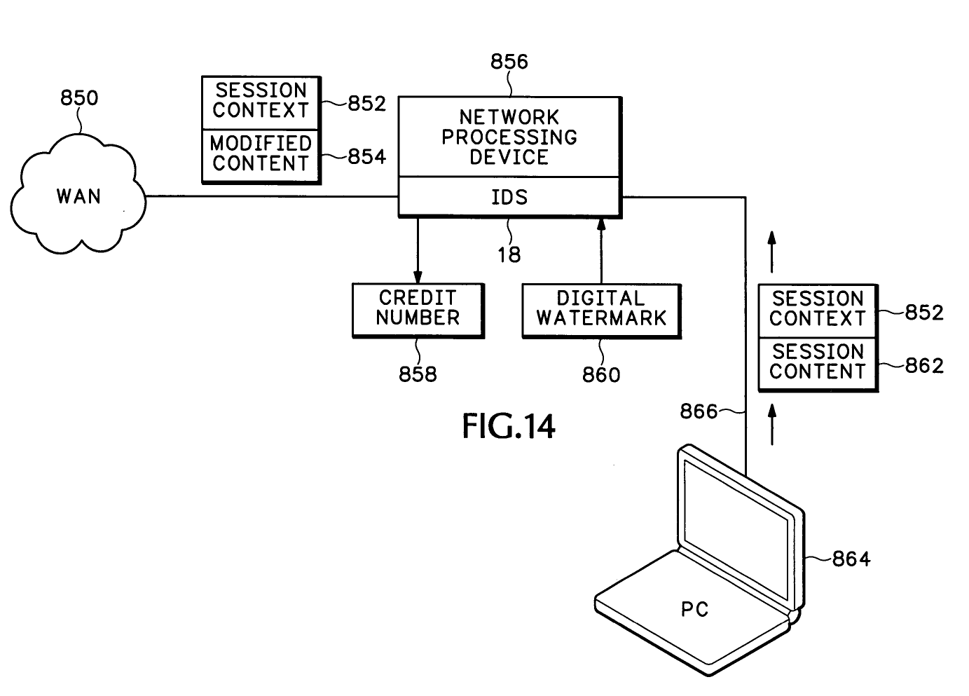

Referring to FIG. 14, the IDS 18 can also be used for adding or modifying information in an identified session context 852. In other words, the IDS 18 is not limited to just dropping packets identified in an intrusion threat. FIG. 14 shows a PC 864 establishing an IP link 866 with a network processing device 856. The IDS 18 operates in device 856 and identifies particular IP session context 852 associated with the IP link 866 as described above. For example, the IDS 18 may identify HTTP messages, FTTP messages, SMTP email messages, etc. that are sent by the PC 864 to another endpoint device operating in WAN 850.

The IDS 18 can be programmed to add or modify particular types of content 862 associated with the identified session context 852. In one example, the IDS 18 may be programmed to remove credit card numbers 858 in documents contained in email or FTTP messages. In another example, the IDS 18 can be programmed to add a digital watermark 860 to any documents that are identified in the FTTP or email documents. The IDS 18 may, for example, add a digital watermark 860 to documents that contain the IP source address of PC 864.

The DXP 180 in the RSP 100 identifies the different session context 852 carried over the IP link 864 as described above. The SPU 200 may then generate tokens that are associated with different types of content 862 associated with the identified session context 852. For example, the SPU 200 may generate tokens that contain email attachments as described above in FIG. 4. The RSP 100 searches any documents contained in the email attachments.

In the first example, the DXP 180 may identify any IP packets that are directed out to WAN 850. The DXP 180 then directs the SPU 200 to search for any documents contained in the packets that include a credit card number. If a credit card number is detected, the IDS 18 replaces the credit card number with a series of “X's that blank out the credit card information. In the second example, the SPU 200 adds the digital watermark 860 to the detected document in the FTTP or email session. The document with the modified credit card information or watermark information is then forwarded to the destination address corresponding to the FTTP or email session.

Similar modifications can be made to any type of content 862 associated with any identified session context 852. For example, a particular IP source or destination address can be changed to another IP address, and then sent back out to the IP network 850 according to some identified session context 852 or session content 862.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

1. An intrusion detection system, comprising:
a data parser identifying syntactic elements in a data stream; and
a threat filtering circuit filtering threat from the data stream according to the syntactic elements identified by the data parser.

2. The intrusion detection system according to claim 1 including a delay buffer used by the threat filtering circuit to delay outputting the data steam for a substantially constant time period while filtering the threats.

3. The intrusion detection system according to claim 2 wherein the threat filtering circuit conducts a first preliminary threat filtering of the data stream using a first set of a priori Access Control List (ACL) filters and conducts a second threat filtering of the data in the delay buffer using a second set of ACL filters generated according to the identified syntactic elements.

4. The intrusion detection system according to claim 1 wherein the threat filtering circuit generates tokens from the identified syntactic elements that are applied to threat signatures to dynamically generate a set of threat filters corresponding to the syntactic elements.

5. The intrusion detection system according to claim 4 wherein the tokes are only generated for syntactic elements in the data stream that may be associated with threats and no tokens are generated for other portions of the data stream.

6. The intrusion detection system according to claim 1 wherein the data parser parses the data according to symbols contained in a parser stack.

7. The intrusion detection system according to clam 6 wherein the parser includes a parser table that contains production rule codes corresponding with the different syntactic elements in the data stream, the production rule codes indexed according to the symbols from the parser stack and portions of the data stream.

8. The intrusion detection system according to claim 7 including a production rule table including production rules indexed by the production rule codes, some of the production rules addressing microinstructions executed by the threat filtering circuit when filtering the threats from the data stream.

9. The intrusion detection system according to claim 1 including a central intrusion detector receiving tokens from threat filtering circuits located in different network processing devices that identify different syntactic elements of different data streams processed by the different network processing devices, the central intrusion detector generating filters according to the different syntactic elements and distributing the filters back to the different network processing devices.

10. The intrusion detection system according to claim 9 wherein the central intrusion detector generates the filters according to network processing operations performed by network processing devices sending the tokens.

11. The intrusion detection system according to claim 1 including a recirculation buffer reassembling fragmented packets from the data stream prior to the threat filtering circuit filtering the threats from the data stream.

12. A semantic processor, comprising:
a Direct Execution Parser (DXP) identifying syntactic elements in a data stream; and
one or more Semantic Processing Units (SPUs) that conduct intrusion detection operations on the data stream according to the syntactic elements identified by the direct execution parser.

13. The semantic processor according to claim 12 including a parser table containing sets of production rule codes indexed by combining non-terminal symbols corresponding to the syntactic elements with portions of the data stream.

14. The semantic processor according to claim 13 including a production rule table containing production rules indexed by the production rule codes in the parser table, at least some of the production rules containing SPU entry point values that index microinstructions executed by the one or more SPU for conducting the intrusion detection operations.

15. The semantic processor according to claim 12 wherein the one or more SPUs compare packets in the data stream with a first set of a priori ACL filters and then either discard or store the packets according to the comparison.

16. The semantic processor according to claim 15 wherein the one or more SPUs store the packets for a fixed delay period while conducting the intrusion detection operations.

17. The semantic processor according to claim 16 wherein one or more SPUs generate tokens from the syntactic elements identified by the DXP and supply the tokens to a threat analyzer that dynamically generates an Access Control List (ACL) corresponding to the tokens.

18. The semantic processor according to claim 17 wherein the one or more SPUs discard any of the stored packets that match the dynamically generated ACL.

19. The semantic processor according to claim 12 including a recirculation buffer used by the one or more SPUs for reassembling fragmented packets in the data stream, the direct execution parser then identifying syntactic elements in the reassembled packets and the one or more semantic processing units (SPUs) conducting intrusion detection operations according to the identified syntactic elements.

20. The semantic processor according to claim 12 wherein the direct execution parser identifies Simple Mail Transport Protocol (SMTP) packets in the data stream and directs the one or more SPUs to extract email elements from the SMTP packets and use the extracted email elements to generate a set of email threat filters that are then applied to the SMTP packets.

21. A method for detecting intrusions in a network processing device, comprising:
receiving a data stream of packets;
identifying an Internet session context for the data stream;
identify elements associated with the identified Internet session context where threats may appear; and
comparing the elements with threat signatures.

22. The method according to claim 21 including:
dynamically generating filters by applying the elements to the threat signatures; and
applying the dynamically generated filters to the data stream.

23. The method according claim 22 including only applying the identified elements to the threat signatures and not applying other portions of the data stream to the threat signatures that do not pose a threat

24. The method according to claim 22 including applying a preliminary set of static filters to the data stream prior to applying the dynamically generated filters.

25. The method according to claim 24 including:
storing the packets in a delay buffer after applying the preliminary set of static filters;
applying the dynamically generated filters to the packets in the delay buffer; and
delaying the output of the packets from the delay buffer for a substantially fixed time period.

26. The method according to claim 21 including:
identifying a Simple Mail Transport Protocol (SMTP) Internet session in the data stream;
extracting a Multipurpose Internet Mail Extension (MIME) attachment from the identified SMTP Internet session; and
comparing the MIME attachment with the threat signatures.

27. The method according to claim 21 including:
combining portions of the packets with non-terminal codes that correspond with the different Internet session context in the data stream;
comparing the combined packet portions and non-terminal codes with grammar entries in a parser table;
using matching grammar entries in the parser table to index production rules in a production rule table;
using the production rules to access micro-instructions that conduct different intrusion detection operations on the data stream.

28. The method according to claim 21 including:
identifying fragmented packets;
reassembling the fragmented packets;
identifying elements associated with the identified Internet Session Context in the reassembled packets; and
generating threat filters according to the identified elements.

29. The method according to claim 21 including:
receiving syntactic elements from different data streams processed by different network processing devices in a private network;
generating a central set of filters by correlating the different syntactic elements from the different network processing devices; and
sending the central set of filters to the different network processing devices.

30. The method according to claim 21 including:
identifying packets containing email messages;
extracting different elements of the email messages from the packets;
generating a set of email filters by applying the email elements to a set of threat signatures; and
applying the set of email filters to the packets identified as containing email messages.
